(19) United States
(12) Patent Application Publication
(10) Pub. No.: US 2007/0266338 A1
(43) Pub. Date: Nov. 15, 2007

(54) INTERNET BROWSING DEVICE, INTERNET BROWSING METHOD, AND PROGRAM RECORDING MEDIUM

(75) Inventor: Takuya Shirai, Osaka (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: KYOCERA MITA CORPORATION, Osaka (JP)

(21) Appl. No.: 11/383,312

(22) Filed: May 15, 2006

(51) Int. Cl. G06F 17/00

(52) U.S. Cl. 715/808

(57) ABSTRACT

An Internet browsing device includes: a web page selecting unit which selects a web page to be displayed; an information obtaining unit which obtains information about pop-up pages linked to the web page selected by the web page selecting unit; a display unit which displays the information obtained by the information obtaining unit; a pop-up page selecting unit which selects information about the pop-up pages to be displayed among the information displayed by the display unit; and a pop-up page displaying unit which opens and displays a pop-up page based on the information selected by the pop-up page selecting unit.

### BACKGROUND OF THE INVENTION

1. Field of the Invention

The present invention relates to an Internet browsing device, a method for browsing the Internet, and a program recording medium.

2. Description of Related Art

Among World Wide Web (WWW) browsers, an automatic page displaying device which can automatically display information linked to a web page is known (see, for example, Japanese Unexamined Patent Application, First Publication No. H11-143674).

Incidentally, in some web pages, links for automatically accessing other web pages (so-called “pop-up pages”) are embedded. When a user accesses such a web page, multiple web pages are automatically displayed regardless of the user's intention. This leads to user frustration and overload of the user's computer.

To solve this problem, a browser having a pop-up page blocking function which stops display of pop-up pages when pop-up pages are linked to a web page which the user chooses is known.

However, some pop-up pages contain information which the user might desire. Since blocking all pop-up pages means giving up a portion of information contained in the web page, it is not always beneficial to the user.

### SUMMARY OF THE INVENTION

The present invention was made considering the aforementioned circumstances and thus it is an object to provide an Internet browsing device, Internet browsing method, and a program recording medium which are able to recognize pop-up pages linked to a web page, and to display a desired pop-up page with a simple operation.

A first aspect of the present invention is an Internet browsing device including: a web page selecting unit which selects a web page to be displayed; an information obtaining unit which obtains information about pop-up pages linked to the web page selected by the web page selecting unit; a display unit which displays the information obtained by the information obtaining unit; a pop-up page selecting unit which selects information about the pop-up pages to be displayed among the information displayed by the display unit; and a pop-up page displaying unit which opens and displays a pop-up page based on the information selected by the pop-up page selecting unit.

The display unit may display the information so as to make it possible for a user to understand a hierarchical relationship of the web page and the pop-up pages.

A second aspect of the present invention is a recording medium on which is recorded a program applicable to a computer having a display, wherein the program includes: a first step of selecting a web page to be displayed; a second step of obtaining information about pop-up pages linked to the web page selected in the first step; a third step of displaying the information obtained in the second step on the display; a fourth step of selecting information about the pop-up pages to be displayed among the information displayed in the third step; and a fifth step of displaying a pop-up page on the display based on the information selected in the fourth step.

The information obtained in the second step may be displayed in the third step so as to make it possible for a user to understand a hierarchical relationship of the web page and the pop-up pages.

A third aspect of the present invention is a method for browsing the Internet including: a first step of selecting a web page to be displayed; a second step of obtaining information about pop-up pages linked to the web page selected in the first step; a third step of displaying the information obtained in the second step; a fourth step of selecting information about the pop-up pages to be displayed among the information displayed in the third step; and a fifth step of displaying a pop-up page based on the information selected in the fourth step.

The information obtained in the second step may be displayed in the third step so as to make it possible for a user to understand a hierarchical relationship of the web page and the pop-up pages.

### BRIEF DESCRIPTION OF THE DRAWINGS

FIG. 1 is a block diagram showing an Internet browser according to an embodiment of the present invention.

FIG. 2 is a flowchart showing operation of the Internet browser shown in FIG. 1.

FIG. 3 is a schematic diagram showing operation of the Internet browser shown in FIG. 1.

FIG. 4 is a schematic diagram showing operation of the Internet browser shown in FIG. 1.

### DETAILED DESCRIPTION OF THE INVENTION

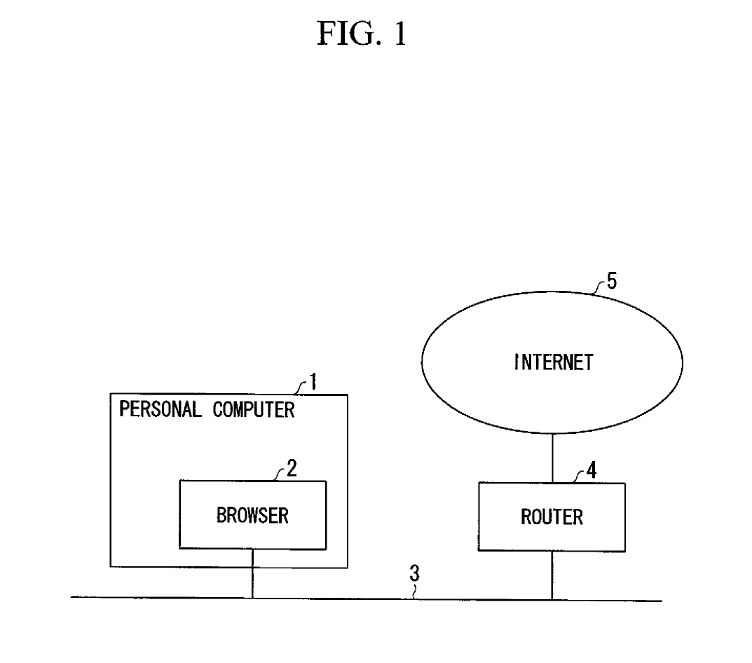

An Internet browsing device according to an embodiment of the present invention is described hereinbelow with reference to the drawings. FIG. 1 is a block diagram showing an Internet browser of this embodiment. In FIG. 1, reference numeral 1 shows a personal computer having a browser 2 installed therein for Internet browsing. Reference numeral 3 shows a network to which the personal computer 1 is connected. The network 3 is connected to the Internet 5 via a router 4. A method for connecting the personal computer 1 to the Internet 5 is not limited to one shown in FIG. 1 and may be other known methods.

Hereinbelow, “pop-up page” means a web page displayed on a browser window which is automatically opened regardless of the intention of a user, when a desired web page is displayed by the browser 2. The term “selected page” means a web page displayed on a browser window after being chosen by the user. In addition, “a web page” is simply referred to as “a page” hereinbelow.

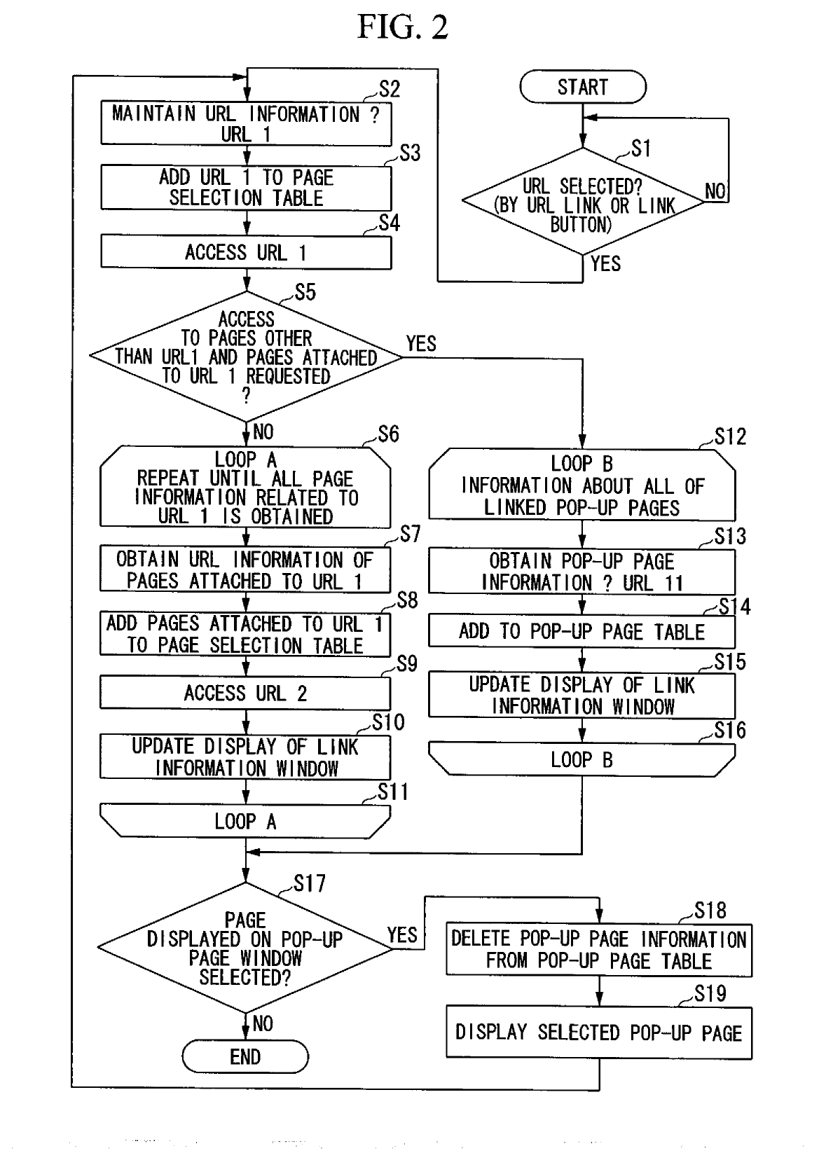

The operation of the browser 2 shown in FIG. 1 is described with reference to FIG. 2. First, the user opens the browser 2 in the personal computer 1 and selects a Uniform Resource Locators (URL) of a page to browse (step S1). The URL is selected by directly inputting the URL or clicking an action button or the like. The browser 2 receives the selection and saves the selected URL information (step S2). Here, the selected URL is referred to as “URL 1”. The browser 2 adds the selected URL information to a selected page table (step S3). The selected page table for saving URL information chosen by the user and a pop-up page table for saving URL information of pop-up pages are provided in the browser 2.

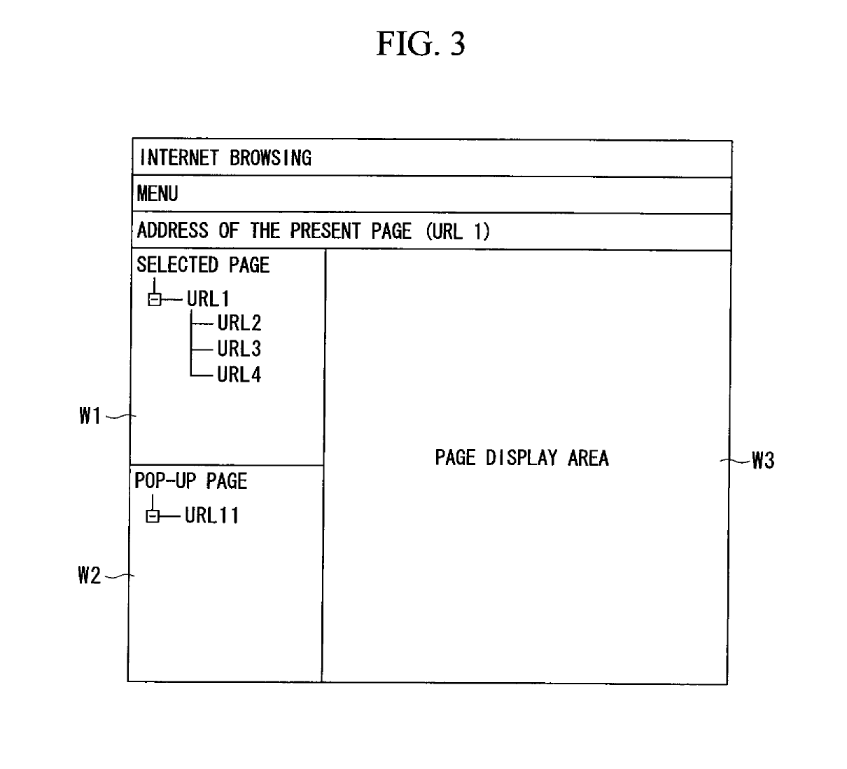

The browser 2 accesses the selected page based on the selected URL information (here, URL 1) (step S4), and determines whether or not access to a page other than the selected page (URL 1) and an attached page of the selected page is requested (that is, whether or not a pop-up page is linked to the selected page) (step S5). After this determination, if there are no aforementioned requests, the browser 2 repeats a loop A shown in FIG. 2 until the browser 2 obtains all link information specified by the selected URL (step S6). These processes are performed as follows. First, the browser 2 obtains URL information of an attached page of the selected page (URL 1) (step S7). The URL of the attached page is referred to as “URL 2”. The URL information about URL 2 is added to the selected page table (step S8). The browser 2 accesses the attached page (URL 2) (step S9) and updates display of a link information window (step S10). By repeating these processes, a selected page display window W1 of the link information window shown in FIG. 3 is displayed (step S10). FIG. 3 shows a case where three pages of URL 2, URL 3, and URL 4 are attached to (linked to) the selected page (URL 1). The link information display window includes the selected page display window W1 and a pop-up page display window W2, which is described below, and can be set to be displayed or not to be displayed in accordance with operation by the user.

On the other hand, if it is determined in step S5 that there is a request for accessing a page other than the selected page (URL 1) and an attached page of the selected page is requested (that is, a pop-up page is linked to the selected page), the browser 2 repeats a loop B shown in FIG. 2 until the browser 2 obtains information of all the pop-up pages linked to the selected URL (step S12). These processes are performed as follows. First, the browser 2 obtains URL information of a pop-up page linked to the selected page (step S13). The URL of the pop-up page is referred to as “URL 11”. The URL information about URL 11 is added on the pop-up page table (step S14). The browser 2 updates display of the link information window (step S15). By repeating these processes, a pop-up page display window W2 of the link information window shown in FIG. 3 is displayed. FIG. 3 shows a case where a pop-up page of URL 11 is linked to the selected page.

Through the aforementioned processes, the browser 2 displays a window as shown in FIG. 3 on the display unit of the personal computer 1. This window includes a page display area W3 for displaying the selected page (a page specified by URL 1), the selected page display window W1 for displaying URL information for the selected page and attached pages thereof, and the pop-up page display window W2 for displaying pop-up page URL information linked to the selected page.

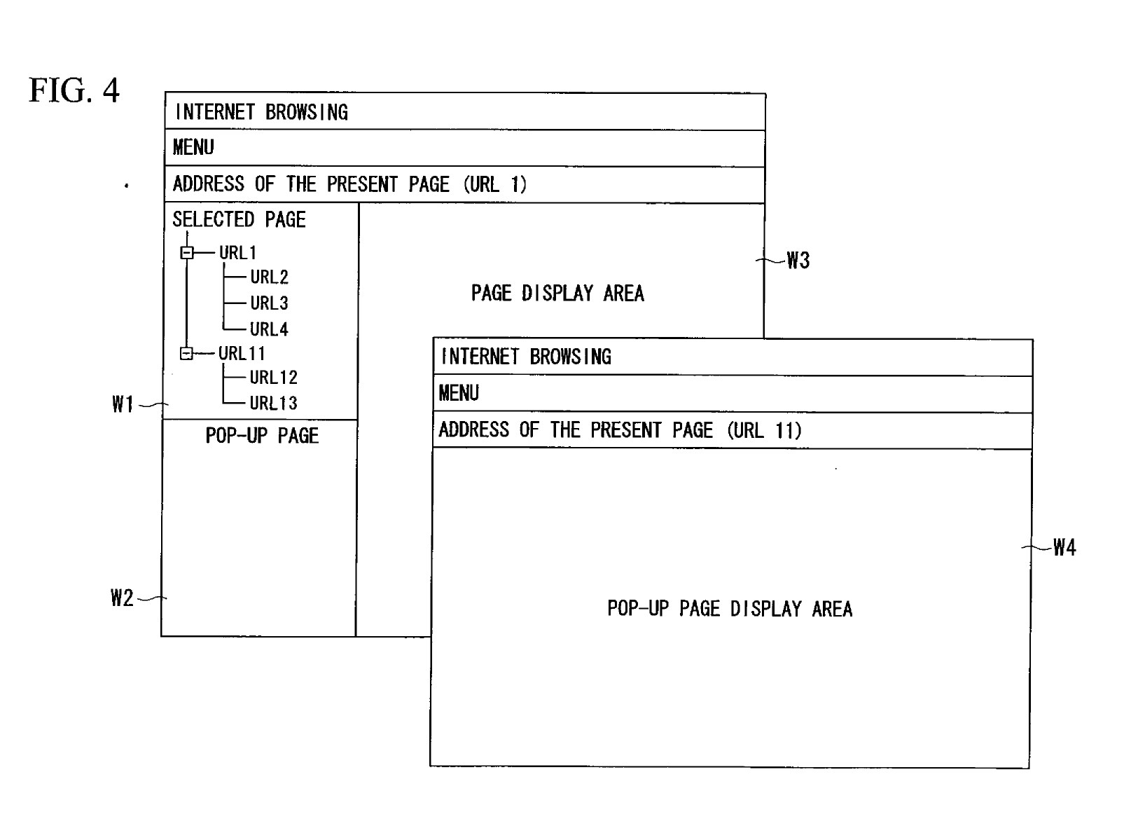

The browser 2 determines whether or not the URL of the pop-up page displayed in the pop-up page display window W2 is selected by the user (step S17). If the URL of the pop-up page is selected, the browser 2 deletes the URL information of the pop-up page from the pop-up page table and the pop-up page display window (step S18). Then the browser 2 opens a second window W4 for displaying the pop-up page as shown in FIG. 4 and displays contents of the pop-up page in the second window W4 (step S 19).

As described above, a window for displaying page information (URL) of pop-up pages which the browser 2 is requested to access is provided. The browser 2 is also adapted to open only pop-up pages selected by a user among the displayed page information. Therefore, the user can understand a condition about pop-up pages linked to the web page and a non-selected pop-up page is prevented from being opened regardless of the intention of the user. As a result, the user can access the selected web page in a comfortable manner and a load on the personal computer can be decreased.

Although FIG. 3 shows a case where a two-layered hierarchical relationship of page information (URL) is displayed in the selected page display window W1 and the pop-up page display window W2, the hierarchical relationship may be three-layered or more (displaying URL of a web page linked to the web page which is linked to the selected web page).

In addition, although URLs are displayed as text in the selected page display window W1 and the pop-up page display window W2 as shown in FIG. 3, preview images of the selected page and the pop-up pages may be displayed instead of the text and be normally displayed when selected by the user. Furthermore, the text and the preview images may be displayed simultaneously in the selected page display window W1 and the pop-up page display window W2.

In step S13 shown in FIG. 2, page information such as a title, a data size, and a time of update of the page may be displayed when such page information is obtained by a HEAD request.

Furthermore, the Internet browsing device may be adapted to save access histories of the selected pages saved in the selected page table which saves URL information of the selected pages and display URL information or a preview image in the selected page display window W1 in order of frequency of access, referring to the access histories of each selected page.

The control of web page display may be performed by recording a program for performing the functions shown in FIG. 2 in a recording medium which is readable by computers, making a computer system read the program recorded in the recording medium, and making the computer system execute the program. The phrase “computer system” includes hardware such as operating systems and peripherals and a WWW system which can provide (or display) homepages. The phrase “a recording medium which is readable by computers” means a flexible disc, magneto-optical disc, ROM (read only memory), CD-ROM and other movable media, or a memory device such as a hard disk contained in a computer system. The phrase “a medium which is readable by computers” also includes media which maintain the program for a certain period such as volatile memory (RAM) provided in a computer system which works as a server or a client when the program is sent via a network such as the Internet or communication lines such as phone lines.

The program may be sent from a computer system which has the program in its memory to another computer system via transmission media or by a transmitted signal in the transmission media. The phrase “transmission media” means media which can transmit information such as the Internet (communication network) or phone lines (communication lines). The program may be one to perform a part of the aforementioned function, and the program may be a differential file (differential program) which enables the computer system to perform the aforementioned function in combination with a program recorded in the computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An Internet browsing device comprising:
a web page selecting unit which selects a web page to be displayed;
an information obtaining unit which obtains information about pop-up pages linked to the web page selected by the web page selecting unit;
a display unit which displays the information obtained by the information obtaining unit;
a pop-up page selecting unit which selects information about the pop-up pages to be displayed among the information displayed by the display unit; and
a pop-up page displaying unit which opens and displays a pop-up page based on the information selected by the pop-up page selecting unit.

2. The Internet browsing device according to claim 1, wherein the display unit displays the information so as to make it possible for a user to understand a hierarchical relationship of the web page and the pop-up pages.

3. A recording medium on which is recorded a program applicable to a computer having a display, wherein the program comprises:
a first step of selecting a web page to be displayed;
a second step of obtaining information about pop-up pages linked to the web page selected in the first step;
a third step of displaying the information obtained in the second step on the display;
a fourth step of selecting information about the pop-up pages to be displayed among the information displayed in the third step; and
a fifth step of displaying a pop-up page on the display based on the information selected in the fourth step.

4. The recording medium according to claim 3, wherein the information obtained in the second step is displayed in the third step so as to make it possible for a user to understand a hierarchical relationship of the web page and the pop-up pages.

5. A method for browsing Internet comprising:
a first step of selecting a web page to be displayed;
a second step of obtaining information about pop-up pages linked to the web page selected in the first step;
a third step of displaying the information obtained in the second step;
a fourth step of selecting information about the pop-up pages to be displayed among the information displayed in the third step; and
a fifth step of displaying a pop-up page based on the information selected in the fourth step.

6. The method for browsing Internet according to claim 5, wherein the information obtained in the second step is displayed in the third step so as to make it possible for a user to understand a hierarchical relationship of the web page and the pop-up pages.
